(19) United States
(12) Patent Application Publication
(10) Pub. No.: US 2008/0201260 A1
(43) Pub. Date: Aug. 21, 2008

(54) Internet micro payments system

(76) Inventor: Toby Unwin, Orlando, FL (US)

Correspondence Address: FURR LAW FIRM, 2622 DEBOLT ROAD, UTICA, OH, 43080, US

(21) Appl. No.: 11/675,820

(22) Filed: Feb. 16, 2007

(51) Int. Cl. G06Q 30/00

(52) U.S. Cl. 705/40

(57) ABSTRACT

The present invention is directed to a method of micro payments over the internet. A user would establish an account with the micropayment service. The user would fund the account via funding method such as a credit card, PayPal, wire transfer, or other method. The user would fund a minimum amount.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of micro payments, more particular making micro payments over the internet.

2. Background

The internet still lacks a good system of making micro payments, generally define as payments for under $10, but they could easily be as high as $100, or as low as fractions of a penny. There are several reasons for this: it is a nuisance to have to re-enter billing details for a small payment; there is a trust factor for all internet payments; fees eat up profits; there are minimum transaction costs, etc.

This stifles internet commerce drastically: it pushes up the price of small transactions; it forces users to “register” for nearly any site; it forces users to buy more product than they need; it discourages sales as buyers seeking a $0.25 product are pushed to $5 or more; it discourages impulse buying as there is a nuisance factor with filling out multiple forms to purchase a product.

The current invention aims to copy the 900 number premium rate phone services whereby anyone with an account can purchase small amounts of information based on the number of page views, time spent, or other methods.

Prior Art

U.S. Pat. No. 5,850,466 by Berger, et al. and issued on Dec. 15, 1998 is for a system, method and article of manufacture for virtual point of sale processing utilizing an extensible, flexible architecture. It has secure transmission of data is provided between a plurality of computer systems over a public communication system, such as the Internet. Secure transmission of data is provided from a customer computer system to a merchant computer system, and for the further secure transmission of payment information regarding a payment instrument from the merchant computer system to a payment gateway computer system. The payment gateway system evaluates the payment information and returns a level of authorization of credit via a secure transmission to the merchant which is communicated to the customer by the merchant. The merchant can then determine whether to accept the payment instrument tendered or deny credit and require another payment instrument. An architecture that provides support for additional message types that are not SET compliant is provided by a preferred embodiment of the invention. A server communicating bidirectionally with a gateway is disclosed. The server communicates to the gateway over a first communication link, over which all service requests are initiated by the server. The gateway uses a second communication link to send service signals to the server. In response to the service signals, the server initiates transactions to the gateway or presents information on an a display device. This system uses credit, while the current invention does not.

U.S. Pat. No. 5,978,840 by Nguyen, et al. and issued on Nov. 2, 1999 is for a system, method and article of manufacture for a payment gateway system architecture for processing encrypted payment transactions utilizing a multichannel, extensible, flexible architecture. This system does not currently support micropayments, they are only an add on and through a point of sale system. The current invention is entirely Internet based.

U.S. Pat. No. 5,987,140 by Rowney, et al. and issued on Nov. 16, 1999 is for a system, method and article of manufacture for secure network electronic payment and credit collection. This is a secure communications protocol, rather than a micropayment system per se.

U.S. Pat. No. 6,029,151 by Nikander and issued on Feb. 22, 2000 is for a Method and system for performing electronic money transactions. It has an ISP handles billing and charging to the customer, the current invention does not involve this as the customer pays directly.

U.S. Pat. No. 6,236,981 by Hill and issue d on May 22, 2001 is for a transaction system. It discloses a digital payment system where a sequence of random numbers is stored at a payment service. A set of digitally encoded random numbers derived from the stored sequence is issued to the user in return for payment. The tokens are stored in a Carnet. The user can then spend the tokens by transferring tokens to a merchant, for example, to an on-line service provider. The merchant returns each token received to the payment server. The payment server authenticates the token and transmits an authentication message to the merchant. The merchant, payment server and user may be linked by internet connections. This invention involves the use of “tokens”. The current invention system simply debits an existing account with real money.

U.S. Pat. No. 6,226,743 by Naor, et al. and issue on May 1, 2001 is for a method for authentication item with the use of an authenticated search tree that serves for authenticating membership or non membership of items in a set.

U.S. Pat. No. 6,260,024 by Shkedy and issued on Jul. 10, 2001 is for a method and apparatus for facilitating buyer-driven purchase orders on a commercial network system. It is for forming buying pools and managing sales/purchasing contracts.

U.S. Pat. No. 6,324,525 by Kramer, et al. and issue on Nov. 27, 2001 is for the settlement of aggregated electronic transactions over a network. It is for the payments between electronic devices.

U.S. Pat. No. 6,609,113 by O'Leary, et al. and issued on Aug. 19, 2003 is for a method and system for processing internet payments using the electronic funds transfer network. This invention uses the EFT(electronic funds transfer) system, while the current invention uses the Internet.

U.S. Pat. No. 6,618,705 by Wang, et al. and issued on Sep. 9, 2003 is for a method and system for conducting business in a transnational e-commerce network. This system involves the transmittal of credit card information to the seller, while the current invention's system avoids this, crediting account on its own servers.

U.S. Pat. No. 6,658,568 by Ginter, et al. and issued on Dec. 2, 2003 is for a trusted infrastructure support system, methods and techniques for secure electronic commerce transaction and rights management. This invention only addresses micropayments in terms of themselves being paid, not as a payment between buyer and seller.

U.S. Pat. No. 6,704,039 by Pena and issued on Mar. 9, 2004 is for a method and system for computer-aided telecommunication and financial transactions. It is limiting because the Users need to visit the website to conduct a transaction.

U.S. Pat. No. 6,704,714 by O'Leary, et al. and issued on Mar. 9, 2004 is for a virtual private lock box. This patent has limited functionality for making electronic payments in the form of EFT credit messages.

U.S. Pat. No. 6,341,273 by Briscoe and issued Jan. 22, 2002 is for an electronic coin stick with potential for future added value. U.S. Pat. No. 6,820,064 by Currans, et al. and issued on Nov. 16, 2004 is for E-commerce consumables. These inventions create an electronic “coin” to make a payment. The current invention simply transfers cash from one account to another.

U.S. Pat. No. 6,836,765 by Sussman and issued on Dec. 28, 2004 is for a system and method for secure and address verifiable electronic commerce transactions. This is a system for secure payment transmission, not a payments system.

U.S. Pat. No. 6,865,559 by Dutta and issued on Mar. 8, 2005 is for a method and system in electronic commerce for inspection-service-based release of escrowed payments. This invention is an Internet based escrow service.

U.S. Pat. No. 5,815,657 by Williams, et al. and issued on Sep. 29, 1998 is for a system, method and article of manufacture for network electronic authorization utilizing an authorization instrument This invention is for an organizational method for on-line payments and not a micropayments system.

U.S. Pat. No. 5,963,924 by Williams, et al. and issued on Oct. 5, 1999 is for a system, method and article of manufacture for the use of payment instrument holders and payment instruments in network electronic commerce. It is an organizational method for on-line payments, not a micro-payments system.

U.S. Pat. No. 6,016,484 by Williams, et al. and issued on Jan. 18, 2000 is for a system, method and article of manufacture for network electronic payment instrument and certification of payment and credit collection utilizing a payment. It delivers payment over a network. It does not debit and credit accounts on a central server. The current invention does not transfer funds over the Internet with each transaction.

U.S. Pat. No. 6,029,150 by Kravitz and issued on Feb. 22, 2000 is for a payment and transactions in electronic commerce system.

U.S. Pat. No. 6,092,053 by Boesch, et al. and issued on Jul. 18, 2000 is for a system and method for merchant invoked electronic commerce. This system keeps and “fills in” customer purchasing information, like the Google “auto-fill” system. It is not a micropayment system, per se.

U.S. Pat. No. 6,178,409 by Weber, et al. and issued on Jan. 23, 2001 is for a system, method and article of manufacture for multiple-entry point virtual point of sale architecture. It covers an order transmittal system, not a micropayment system.

There is still room for improvement in the art.

### SUMMARY OF THE INVENTION

The present invention is directed to a method of micro payments over the internet. A user would establish an account with the micropayment service. The user would fund the account via funding method such as a credit card, PayPal, wire transfer, or other method. The user would fund a minimum amount.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The internet still lacks a good system of making micro payments, generally define as payments for under $10, but they could easily be as high as $100, or as low as fractions of a penny. There are several reasons for this: it is a nuisance to have to re-enter billing details for a small payment; there is a trust factor for all internet payments; fees eat up profits; there are minimum transaction costs, etc.

The current invention is a system 1 and method of making micro payments over the internet.

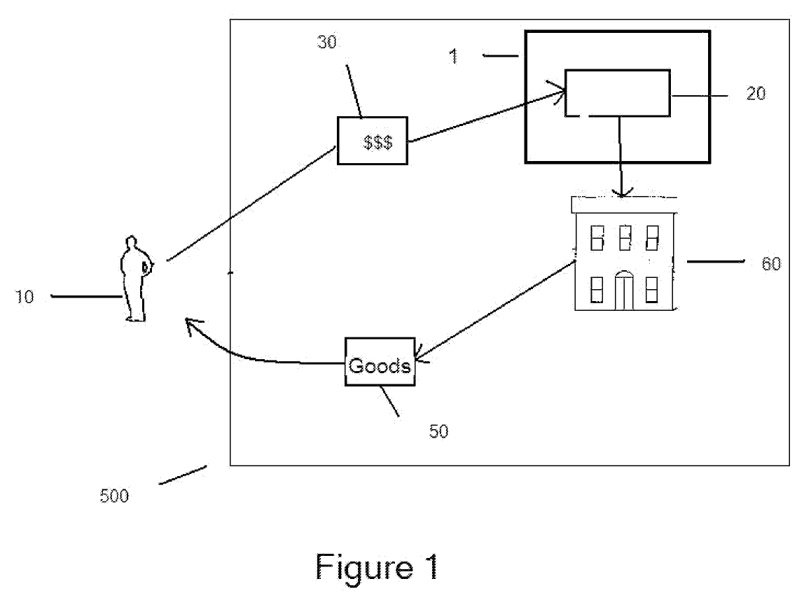

As shown in FIG. 1, a user 10 would establish an account 20 with the micropayment service 30. The user 10 would fund the account 20 via funding method 30 such as a credit card, PayPal, wire transfer, or other method. In the preferred embodiment, the user 10 would fund a minimum amount ($10 suggested).

When the user 10 visits a companies website 60 that accepts these micropayments they are invited to click through to complete the transaction. The cost of clicking is displayed to the user 10.

The system 1 can either recognize the user's computer's I.P. address to maintain a logged in user 10, or the user 10 can log in to the system 1 with a user name and password. A program or browser window could run in the background keeping a user 10 logged in if necessary.

When the user 10 has clicked to accept the transaction the micropayments system 1 is queried via the Internet 500 to confirm the account 20 has sufficient balance to cover the transaction cost. If it does the seller's account is credited and their account 20 is credited with the money while the buyer's account is debited. When a user 10 has a low balance they are notified by email. The company will forward the purchased goods or services 50 to the User 10.

The micropayments system 1 earns its money by charging a percentage of the transaction to either buyer, seller or both, a transaction fee to either party, selling advertising on its site, or a combination of these.

With the system 1 there is a savings in time of entering registration and payment information. It also has no need for minimum transaction costs. It provides a safe, trusted payments system.

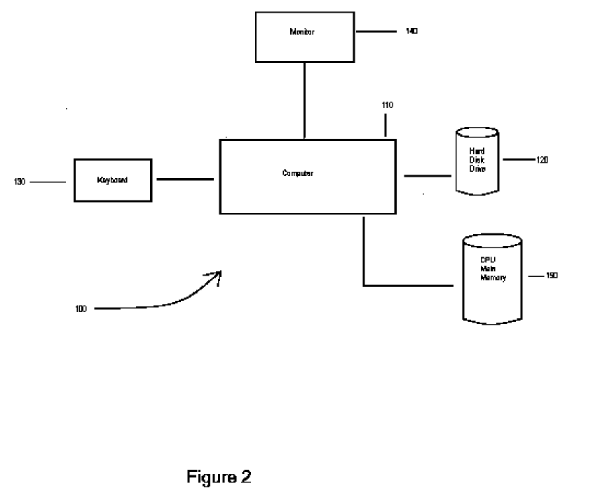

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

Advantages

The advantages of this system are: A savings in time of entering registration and payment information. No need for minimum transaction costs. The system is a safe, trusted payments system. The system 1 will lower on-line losses, as amounts and account balances are smaller. It enables the creation of new business that do not currently exist, e.g. the selling of small items of information, e.g. articles, fonts, photographs, ring tones, that are currently to cheap to charge for, yet still have value.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for making micropayments comprising the steps: having a user establish an account with a system, funding said account and using said account to make a micropayment.

2. The method as defined in claim 1, wherein said account would be funded with a minimum amount.

3. The method as defined in claim 1, where said payments are made to a company that accepts payment from said system.

4. The method as defined in claim 3, wherein said company does business on a website.

5. The method as defined in claim 1, where said the cost of clicking is displayed to the user.

6. The method as defined in claim 1, where said system will recognize the user's I.P. address.

7. The method as defined in claim 1, where said user can log in to the system with a username and password.

8. The method as defined in claim 1, where said confirms that the account has enough balance to cover the mircopayment.

9. The method as defined in claim 1, where said system will notify a user of a low balance.

10. The method as defined in claim 1, where said system charges a percentage of the transaction.

11. The system as defined in claim 1, where said system will have advertisement.

12. A method for making micropayments comprising the steps: having a user establish an account with a system, funding said account and using said account to make a micropayment, where said account would be funded with a minimum amount, where said payments are made to a company that accepts payment from said system where said confirms that the account has enough balance to cover the micropayment.

13. The method as defined in claim 12, wherein said company does business on a website.

14. The method as defined in claim 12, where said the cost of clicking is displayed to the user.

15. The method as defined in claim 12, where said system will recognize the user's I.P. address.

16. The method as defined in claim 12, where said user can log in to the system with a username and password.

17. The method as defined in claim 12, where said system will notify a user of a low balance.

18. The method as defined in claim 12, where said system charges a percentage of the transaction.

19. The system as defined in claim 12, where said system will have advertisement.
